(19) United States
(12) Patent Application Publication
(10) Pub. No.: US 2009/0095363 A1
(43) Pub. Date: Apr. 16, 2009

(54) PRESSURE CONTROL VALVE, PRODUCTION METHOD OF PRESSURE CONTROL VALVE, AND FUEL CELL SYSTEM WITH PRESSURE CONTROL VALVE

(75) Inventors: Toru Nakakubo, Kawasaki-shi (JP); Akiyoshi Yokoi, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/297,574

(22) PCT Filed: Aug. 24, 2007
(86) PCT No.: PCT/JP2007/066958

§ 371 Date: Oct. 17, 2008

(30) Foreign Application Priority Data
Aug. 29, 2006 (JP) 2006-232754

(51) Int. Cl. F16K 15/14; B21D 51/16

(52) U.S. Cl. 137/843; 29/890.124

(57) ABSTRACT

There are provided a pressure control valve which has sealing characteristics and durability, functions also as a temperature-dependent cutoff valve, and can be reduced in size; a method of producing the pressure control valve; and a fuel cell system having the pressure control valve mounted thereon. The pressure control valve includes a movable part which operates by a differential pressure, a valve part, and a transmission mechanism for transmitting an action of the movable part to the valve part, wherein either one of the movable part and the valve part is separated from the transmission mechanism.

### TECHNICAL FIELD

The present invention relates to a pressure control valve, a production method of a pressure control valve, and a fuel cell system having a pressure control valve.

### BACKGROUND ART

Hitherto, various pressure reducing valves have been produced using mechanical processing technology.

The pressure reducing valve is mainly classified into an active drive type and a passive drive type.

The active drive type pressure reducing valve is equipped with a pressure sensor, a valve driving unit, and a control mechanism, and the valve is driven so that a secondary pressure may be reduced to a set pressure.

In contrast, the passive drive type pressure reducing valve is constituted such that the valve opens and closes automatically utilizing a differential pressure when the pressure reaches a set pressure.

Further, the passive type pressure reducing valve is mainly classified into a pilot type and a direct drive type. The pilot type has a pilot valve and is characterized by stable operation.

In contrast, the direct drive type is advantageous in high speed response.

When gas is used as working fluid, in order to surely perform the opening/closing of a valve even by a minute force of compressible fluid, a diaphragm is generally used as a differential pressure sensing mechanism.

Usually, in the direct drive diaphragm pressure reducing valve, a diaphragm, a transmission mechanism for transmitting the action of the diaphragm to a valve body, such as a piston, and the valve body are integrally connected with a screw or the like.

However, in a valve equipped with a relief mechanism such as shown in Japanese Patent Application Laid-Open No. H10-268943, a diaphragm (movable part) and a transmission mechanism are separately provided for realizing a relief operation.

This is because, when a secondary pressure in a pressure reducing valve becomes higher than a predetermined pressure, the diaphragm (movable part) bends to the atmosphere side and is made distant from a piston (transmission mechanism), thereby releasing excessive pressure through a port provided in the diaphragm (movable part).

In order to realize a relief mechanism, the valve body and the transmission mechanism need to be supported by a member other than the diaphragm (movable part).

Generally, the support is achieved by providing a guide at a valve body or a periphery thereof and also by providing a coiled spring on the side opposite to the transmission mechanism relative to the valve body on a movable shaft of the transmission mechanism.

In Japanese Patent Application Laid-Open No. H10-268943, a spring for closing a valve is provided so as to be opposed to the piston (transmission mechanism) through the valve body on an extension of the axis of the piston (transmission mechanism).

With respect to a compact pressure reducing valve, as disclosed in Japanese Patent Application Laid-Open No. 2004-031199, a valve is proposed which includes a diaphragm, a valve body, and a valve shaft that directly connects the valve body and the diaphragm.

As a method of producing a pressure reducing valve with such a structure, there is known a method which is disclosed in A. Debray et al, J. Micromech. Microeng. 15, S202 to S209 (2005). The production method is featured in that small mechanical elements are produced by using semiconductor processing technology.

In the semiconductor processing technology, a semiconductor substrate is used as a material and a structure is formed by combining technologies such as film deposition, photolithography, and etching.

Therefore, the semiconductor processing technology is advantageous in that fine processing of a submicron order is possible, and mass production is also easily achieved by a batch process.

In particular, because the pressure reducing valve has a complicated three-dimensional structure, there are employed reactive ion etching (ICP-RIE) for vertically etching a semiconductor substrate, bonding technology for bonding two or more semiconductor substrates and the like.

Further, a valve body and a valve seat are joined through a sacrificial layer such as of silicon oxide or the like, and, in the latter half of the process, the valve body is released from the valve seat by etching the sacrificial layer.

On the other hand, compact fuel cells are attracting attention as an energy source for mounting in a compact electric instrument.

The fuel cell is useful as a drive source for the compact electric instrument because the energy that can be supplied per unit volume or per unit weight is several times to almost ten times that of the conventional lithium ion secondary battery.

Particularly in a fuel cell for providing a large output, it is optimum to utilize hydrogen as the fuel. However, since hydrogen is gaseous at normal temperature, there is required a technology for storing hydrogen at a high density in a small fuel tank.

The below-mentioned methods are known as the technology for such hydrogen storage.

A first method is to compress and store hydrogen in a state of high-pressure gas. When the gas pressure in a tank is set to 200 atm, the hydrogen volume density becomes about 18 mg/cm³.

A second method is to cool hydrogen to a low temperature and to store it as a liquid. This method is capable of high-density storage, though it involves such disadvantages that a large energy is required for liquefying hydrogen and that hydrogen may spontaneously vaporize and leak.

A third method is to store hydrogen by use of a hydrogen storage alloy. This method has a problem that the fuel tank becomes heavy because the hydrogen storage alloy having a large specific gravity can absorb only about 2% by weight of hydrogen, but is effective for size reduction because the storage amount per unit volume is large.

In a polymer electrolyte fuel cell, electric power generation is conducted in the following manner. As a polymer electrolyte membrane, a cation exchange resin based on perfluorosulfonic acid is often utilized.

For such membrane, for example DuPont's Nafion is well known. A membrane electrode assembly, which is formed by interposing a polymer electrolyte membrane with a pair of porous electrodes bearing a catalyst such as platinum, namely with a fuel electrode and an oxidizer electrode, constitutes a power generating cell. By supplying the oxidizer electrode with an oxidant and the fuel electrode with a fuel in such a power generating cell, protons move across the polymer electrolyte membrane to perform electric power generation.

The polymer electrolyte membrane generally has a thickness of about 50 to 200 μm, in order to maintain the mechanical strength and in order that the fuel gas does not permeate thereinto. Such polymer electrolyte membrane has a strength of about 3 to 5 kg/cm².

Therefore, in order to prevent breakage of the membrane by a differential pressure, it is preferable to control a differential pressure between an oxidizer electrode chamber and a fuel electrode chamber in a fuel cell at 0.5 kg/cm² or less in an ordinary state and 1 kg/cm² or less even in an abnormal state.

In the case where the differential pressure between a fuel tank and an oxidizer electrode chamber is smaller than the above described pressure, the fuel tank and the fuel electrode chamber may be directly connected to each other without any pressure reduction.

However, in the case where an oxidizer electrode chamber is made open to the atmosphere and a fuel is filled at a higher density, it becomes necessary to reduce the pressure in the course of fuel supply from the fuel tank to the fuel electrode chamber.

Also the aforementioned mechanism is required for activation/suspension of power generation and in order to stabilize the generated electric power. Japanese Patent Application Laid-open No. 2004-031199 discloses a technology in which a small valve is provided between a fuel tank and a fuel cell unit, thereby preventing the fuel cell unit from being broken due to a large differential pressure, also controlling activation/suspension of the power generation and stably maintaining the generated electric power.

In particular, a diaphragm is provided at a boundary between a fuel supply path and an oxidizer supply path, and is directly connected with the valve to drive the valve by a differential pressure between the fuel supply path and the oxidizer supply path without utilizing an electric power, thereby realizing a pressure reducing valve, which optimally controls the fuel pressure to be supplied to the fuel cell unit.

However, the pressure reducing valves equipped with the conventional relief mechanism have the following problems.

In the pressure reducing valve disclosed in Japanese Patent Application Laid-Open No. H10-268943 mentioned above, the diaphragm (movable part) and the piston (transmission mechanism) are separated, but the spring for closing the valve is provided on the side opposite to the piston (transmission mechanism) side of the valve body on an extension of the axis of the piston (transmission mechanism).

Therefore, the number of layers of the layered structure of the pressure reducing valve is increased, which complicates the structure.

Further, in such a structure, in order to prevent positional deviation of the valve body, it is necessary to provide a guide at the valve body, the piston (transmission mechanism) or the like, in addition to the provision of the spring.

However, in the compact pressure reducing valve, it is extremely difficult to produce a compact bearing.

Therefore, there is the problem that friction at the guide portion is large and it is therefore difficult to drive a valve.

In contrast, in the pressure reducing valve using semiconductor processing technology as described in Japanese Patent Application Laid-Open No. 2004-31199 mentioned above, the diaphragm (movable part), the piston (transmission mechanism), and the valve body are integrally joined by bonding. Therefore, when the secondary pressure in the pressure reducing valve excessively increases, a large stress is applied to the piston (transmission mechanism) and the valve body, which may result in breakage thereof.

In particular, because a large bonding strength is required, there is a fear that the generation rate of defective units due to poor bonding strength may increase.

Further, when there is a step of bonding a plurality of semiconductor substrates and then releasing a sacrificial layer, coating with an elastic material or the like can be carried out in order to improve the sealing property of the valve body or the valve seat surface, which has the following problems.

That is, the production process is complicated and moreover, it is difficult to provide a sealing layer in a sufficient thickness. Further, in compact fuel cells equipped with the conventional compact pressure reducing valve, the sealing of the valve parts is insufficient, and therefore there is a fear of damaging a fuel cell by leakage.

Further, there is also a fear that because the compact pressure reducing valve is expensive, the production cost of a fuel cell may increase.

### DISCLOSURE OF THE INVENTION

The present invention is directed to a pressure control valve which has sealing property, durability, and a function of a temperature-dependent cutoff valve and can be reduced in size; a method of producing the pressure control valve; and a fuel cell system having the pressure control valve mounted thereon.

In order to solve the above-mentioned problems, the present invention provides a pressure control valve having the following structure, a method of producing the pressure control valve, and a fuel cell system having the pressure control valve mounted thereon.

The pressure control valve of the present invention is characterized by including:

a movable part which operates by a differential pressure;

a valve part; and

a transmission mechanism for transmitting an action of the movable part to the valve part,

wherein either one of the movable part and the valve part is separated from the transmission mechanism.

Further, the pressure control valve of the present invention is characterized in that the movable part is a diaphragm.

Moreover, the pressure control valve of the present invention is characterized in that the valve part includes a valve seat portion, a valve body portion, and a support portion for supporting the valve body portion, wherein the support portion supports the valve body portion such that a gap between the valve body portion and the valve seat portion is formed or eliminated according to the action of the movable part transmitted by the transmission mechanism.

Further, the pressure control valve of the present invention is characterized in that the support portion for supporting the valve body portion is constituted of an elastic body for supporting the valve body portion provided on a flat plane which is perpendicular to a direction of the action of the transmission mechanism and includes the valve body portion.

Moreover, the pressure control valve of the present invention is characterized in that the support portion for supporting the valve body portion includes, as a part thereof, a temperature-dependent displacing portion which is displaced to a location where the valve part is closed at a temperature equal to or higher than a threshold.

Further, the pressure control valve of the present invention is characterized in that the temperature-dependent displacing portion is formed of a shape memory alloy.

Moreover, the pressure control valve of the present invention is characterized in that the temperature-dependent displacing portion is formed of a bimetal.

Further, the pressure control valve of the present invention is characterized in that the valve body portion has a projection portion formed on a portion for abutting against the valve seat portion.

Moreover, the pressure control valve of the present invention is characterized by including a sealing material formed on either one of the valve body portion and the valve seat portion at an abutting portion of the valve body portion and the valve seat portion.

Further, the pressure control valve of the present invention is characterized in that the valve part includes an elastic body with a through hole provided on a flat plane which is perpendicular to a direction of an action of the transmission mechanism and includes the valve body portion, and wherein the through hole is opened and closed by a tip of the transmission mechanism according to the action of the movable part transmitted by the transmission mechanism.

Moreover, the pressure control valve of the present invention is characterized in that the transmission mechanism is formed of a plurality of projection portions provided on the movable part.

Further, the pressure control valve of the present invention is characterized in that the transmission mechanism is formed of a seat having unevenness (or irregularities) on a surface thereof provided between the movable part and the valve part.

Moreover, the pressure control valve of the present invention is characterized in that each of the valve part, the movable part, and the transmission mechanism is formed of one of a sheet-shaped member and a plate-shaped member, and those members are stacked to constitute the pressure control valve.

Further, the pressure control valve of the present invention is characterized by being a pressure reducing valve.

The present invention also provides a method of producing a pressure control valve having a movable part which operates by a differential pressure, a valve part including a valve seat portion, a valve body portion, and a support portion for supporting the valve body portion, and a transmission mechanism for transmitting an action of the movable part to the valve part, either one of the movable part and the valve part being separated from the transmission mechanism, the method including:

forming a movable part using one of a sheet-shaped member and a plate-shaped member;

forming a transmission mechanism using one of a sheet-shaped member and a plate-shaped member;

forming a valve seat portion using one of a sheet-shaped member and a plate-shaped member;

forming a valve body portion and a support portion using one of a sheet-shaped member and a plate-shaped member; and

stacking the above formed components on one another to assemble a pressure control valve.

Further, the method of producing the pressure control valve of the present invention is characterized in that a semiconductor substrate is used in at least a part of one of the sheet-shaped member and the plate-shaped member.

Moreover, the method of producing the pressure control valve of the present invention is characterized in that at least one of etching, pressing, and injection molding is used for each of the movable part formation, the transmission mechanism formation, the valve seat portion formation, the valve body portion formation, and the support portion formation.

Further, the method of producing the pressure control valve of the present invention is characterized by including:

after the formation of the valve body portion and the support portion or the formation of the valve seat portion, coating at least one of the formed valve body portion and support portion and the formed valve seat portion with a sealing material; and

then assembling the valve body portion and the support portion, and the valve seat portion.

The present invention also provides a fuel cell system characterized by having mounted thereon any one of the above-mentioned pressure control valves or a pressure reducing valve obtained by any one of the above-mentioned methods for producing the pressure control valve.

According to the present invention, there can be realized a pressure control valve which has sealing characteristics and durability, functions also as a temperature-dependent cutoff valve, and can be reduced in size; a method of producing the pressure control valve; and a fuel cell system having the pressure control valve mounted thereon.

Further features of the present invention will become apparent from the following description of exemplary embodiments with reference to the attached drawings.

### BRIEF DESCRIPTION OF THE DRAWINGS

FIG. 1 is a schematic cross-sectional view illustrating a first structural example of a compact pressure reducing valve according to First Embodiment of the present invention.

FIGS. 2A and 2B are schematic plan views illustrating first and second forms of a support portion in the first structural example of the compact pressure reducing valve according to First Embodiment of the present invention.

FIG. 3 is a schematic cross-sectional view illustrating an application example of the first structural example of the compact pressure reducing valve according to First Embodiment of the present invention.

FIG. 4 is a schematic cross-sectional view illustrating the pressure and cross section of each part of the first structural example of the compact pressure reducing valve (closed state) according to First Embodiment of the present invention.

FIG. 5 is a schematic cross-sectional view illustrating an open state of a valve of the first structural example of the compact pressure reducing valve according to First Embodiment of the present invention.

FIG. 6 is a schematic cross-sectional view illustrating a modified form of the first structural example of the compact pressure reducing valve according to First Embodiment of the present invention.

FIG. 7 is an exploded perspective view illustrating the first structural example of the compact pressure reducing valve according to First Embodiment of the present invention.

FIGS. 8A, 8B, 8C, 8D, 8E, 8F, 8G, 8H, 8I, 8J, 8K, and 8L are schematic cross-sectional views illustrating the production steps of a first production process of a compact pressure reducing valve having the structure of First Embodiment according to Second Embodiment of the present invention.

FIGS. 9A, 9B, 9C, 9D, 9E, 9F, 9G, 9H, 9I, 9J, 9K, and 9L are schematic cross-sectional views illustrating the production steps of a second production process of a compact pressure reducing valve having the structure of First Embodiment according to Third Embodiment of the present invention.

FIGS. 10A, 10B, 10C, 10D, 10E, 10F, 10G, 10H, 10I, 10J, 10K, 10L, and 10M are schematic cross-sectional views illustrating the production steps of a third production process of a compact pressure reducing valve having the structure of First Embodiment according to Fourth Embodiment of the present invention.

FIG. 11 is a schematic cross-sectional view illustrating a second structural example of the compact pressure reducing valve according to Fifth Embodiment of the present invention.

FIG. 12 is a schematic cross-sectional view illustrating a valve opened state of the second structural example of the compact pressure reducing valve according to Fifth Embodiment of the present invention.

FIG. 13 is a schematic cross-sectional view illustrating another form of a transmission mechanism of the second structural example of the compact pressure reducing valve according to Fifth Embodiment of the present invention.

FIG. 14 is an exploded perspective view illustrating the second structural example of the compact pressure reducing valve according to Fifth Embodiment of the present invention.

FIG. 15 is a schematic cross-sectional view illustrating a third structural example of the compact pressure reducing valve according to Sixth Embodiment of the present invention.

FIG. 16 is a schematic cross-sectional view illustrating a fourth structural example of the compact pressure reducing valve according to Sixth Embodiment of the present invention.

FIG. 17 is a schematic cross-sectional view illustrating a fifth structural example of the compact pressure reducing valve according to Seventh Embodiment of the present invention.

FIG. 18 is a schematic plan view illustrating a fifth structural example of the compact pressure reducing valve according to Seventh Embodiment of the present invention.

FIGS. 19A and 19B are schematic cross-sectional views illustrating the fifth structural example of the compact pressure reducing valve according to Seventh Embodiment of the present invention.

FIG. 20 is a graphical representation of flow rate vs. temperature characteristics explaining the fifth structural example of the compact pressure reducing valve according to Seventh Embodiment of the present invention.

FIG. 21 is a schematic perspective view illustrating a fuel cell according to Eighth Embodiment of the present invention.

FIG. 22 is a schematic diagram illustrating a fuel cell system according to Eighth Embodiment of the present invention.

FIG. 23 is a table illustrating dissociation pressure of hydrogen storage alloy (LaNi₅) in the fuel cell system according to Eighth Embodiment of the present invention.

FIG. 24 is a schematic cross-sectional view illustrating the positional relationship of the compact pressure reducing valve in the fuel cell according to Eighth Embodiment of the present invention.

### BEST MODE FOR CARRYING OUT THE INVENTION

Embodiments of the present invention will be described in detail with reference to the attached drawings.

### First Embodiment

In First Embodiment, a first structural example of a pressure reducing valve as a pressure control valve of the invention is described.

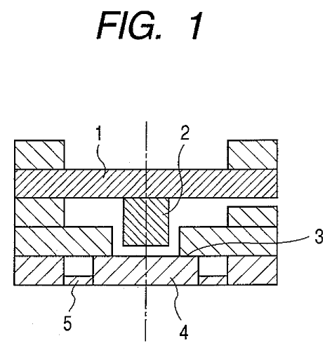

FIG. 1 is a schematic cross-sectional view illustrating the structure of the pressure reducing valve of this embodiment.

In FIG. 1, reference numerals 1, 2, 3, 4, and 5 denote a diaphragm (movable part), a piston (transmission mechanism), a valve seat portion, a valve body portion, and a support portion, respectively.

The pressure reducing valve in this embodiment includes the diaphragm 1 which serves as a movable part, the piston 2 which is a transmission mechanism, and the valve seat portion 3, the valve body portion 4, and the support portion 5 which form a valve part. In particular, the valve body portion 4 is circumferentially supported by the support portion 5.

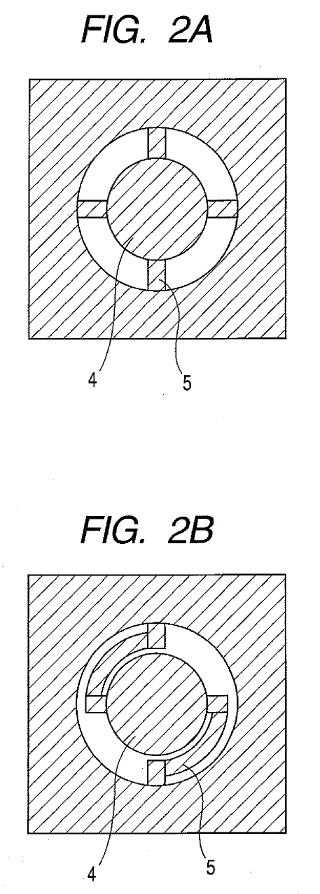

The support portion 5 is formed of a beam having elasticity, and can take forms such as shown in FIGS. 2A and 2B.

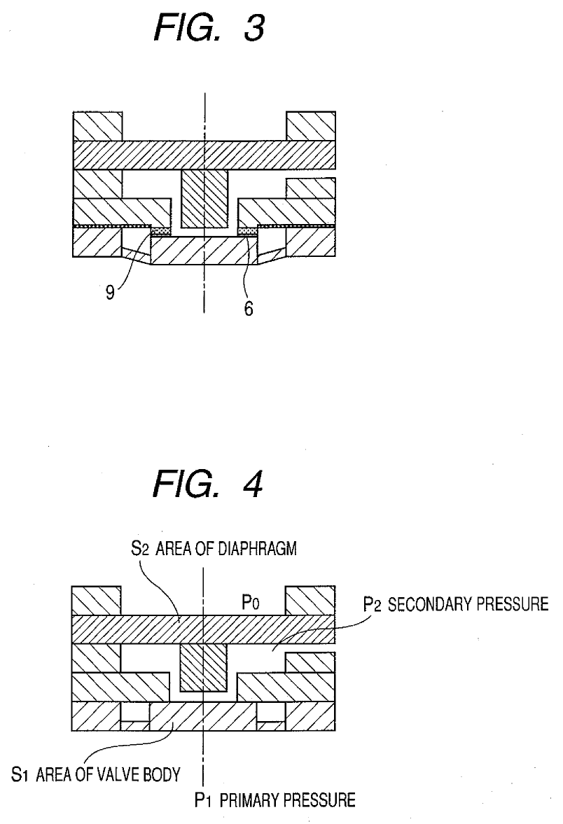

When a projection portion is provided to the valve seat portion 3 or the valve body portion 4 such as shown in FIG. 3, the spring of the support portion is in a bended state even when the valve is closed, to apply force in the closing direction, thereby improving the sealing property.

Further, the sealing property can be improved by coating at least one surface of the valve body portion 4 and the valve seat portion 3 with a sealing material 6 of the valve. Hereinafter, the operation of the pressure reducing valve will be described with reference to FIG. 4.

The pressure at a location above the diaphragm (movable part) 1 is defined as P₀, the primary pressure at upstream of the valve is defined as P₁, the pressure at downstream of the valve is defined as P₂, the area of the valve body portion 4 is defined as S₁, and the area of the diaphragm (movable part) 1 is defined as S₂.

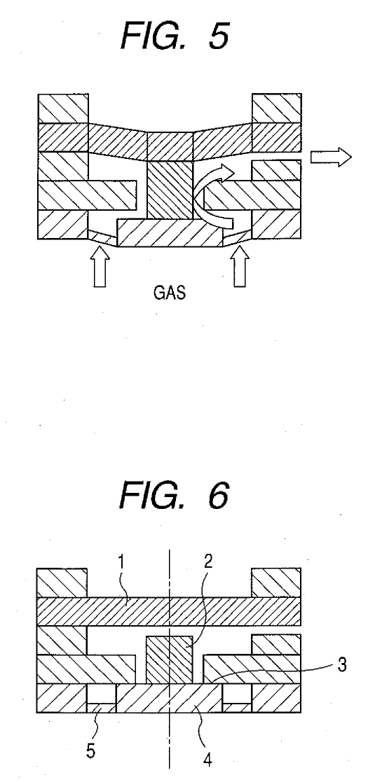

At this time, the condition under which the valve opens as shown in FIG. 5 based on the balance of the pressures is expressed by (P₁−P₂) S₁<(P₀−P₂)S₂. When P₂ is higher than the pressure which satisfies the condition, the valve is closed, and when P₂ is lower than that pressure, the valve opens.

Thereby, the pressure P₂ can be kept constant.

The pressure at which the valve opens/closes and the flow rate can be optimally designed by adjusting the area of the valve body portion 4, the area of the diaphragm (movable part) 1, the length of the piston (transmission mechanism) 2, the thickness of the diaphragm (movable part) 1, and the shape of the beam of the support portion 5.

In particular, when the spring constant of the diaphragm (movable part) 1 is larger than the spring constant of the support portion 5, the pressure at which the valve opens depends on the diaphragm (movable part) 1. In contrast, when the spring constant of the support portion 5 is larger than the spring constant of the diaphragm (movable part) 1, the behavior of the valve depends on the support portion 5. Further, when a projection portion 9 is provided as shown in FIG. 3, the sealing property of the valve and the pressure at which the valve operates change depending on the height of the projection portion 9.

On the other hand, when the pressure P₂ at the downstream of the valve becomes higher than a set pressure, the diaphragm (movable part) 1 bends upward, whereby the valve is closed.

At this time, because the piston (transmission mechanism) 2 is not joined to the valve body portion 4, the valve body portion 4 stops when brought into contact with the valve seat portion 3, and only the piston (transmission mechanism) 2 moves together with the diaphragm (movable part) 1.

This can prevent the valve from being damaged by an increase in the pressure.

Further, as shown in FIG. 6, the pressure reducing valve of the present embodiment can be structured in such a manner that the transmission mechanism 2 is joined integrally to the valve body portion 4, and is separated from the movable part 1. In this case, the principle of operation is also the same as that of the structure shown in FIG. 1.

The pressure reducing valve of this embodiment can be produced using mechanical processing technology as follows.

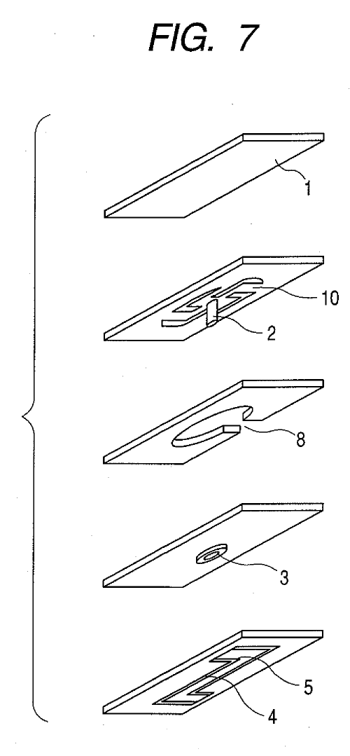

FIG. 7 is an exploded perspective view when the pressure reducing valve is viewed from the valve body portion 4 side. As shown in the perspective view, the pressure reducing valve is produced by stacking sheet-shaped members.

The size of each member is 8 mm×8 mm.

For the diaphragm (movable part) 1, elastic materials such as Viton (trade name; manufactured by DuPont) rubber and silicone rubber, metallic materials such as stainless steel and aluminum, plastics, etc., can be used. When stainless steel is used as a material for the diaphragm 1, the piston can be produced integrally with the diaphragm 1 by etching, cutting, etc.

In this embodiment, a hot melt sheet (produced by NITTO SHINKO CORPORATION) having a 25 μm thick adhesive layer with a gas sealing property on a 50 μm thick PET base material was used for the diaphragm 1.

Further, as the piston, a member having a diaphragm support portion 10 and a piston (transmission mechanism) 2 integrally formed therewith was produced by etching of stainless steel.

The thickness of the diaphragm support portion 10 was 50 μm and the height of the piston 2 was 250 μm.

The hot melt sheet and the stainless steel (SUS) member were heated in a superimposed state to about 140° C. and held for several seconds to be adhered to each other.

A space below the diaphragm (movable part) 1 and a flow path through which the piston (transmission mechanism) 2 passes can be produced by mechanical processing or etching processing of a stainless steel body. In this embodiment, a hot melt sheet (produced by NITTO SHINKO CORPORATION) having a 25 μm thick adhesive layer with a gas sealing property on a 50 μm thick PET base material was used for forming the space below the diaphragm (movable part) 1. The flow path through which the piston (transmission mechanism) 2 passes can be produced by mechanical processing or etching processing of a stainless steel body. A 250 μm thick stainless steel plate was etched in such a manner that the height of the projection portion of the valve seat portion 3 was 100 μm.

The coating of the valve seat portion 3 or the valve body portion 4 with a sealing material may be performed by vapor deposition of Parylene, Teflon (trade name; manufactured by DuPont) or the like, or by applying silicone rubber, polyimide, Teflon, or the like by means of spin coating or spraying coating.

In this embodiment, silicone rubber was applied to a member having a valve seat portion by spin coating (3000 RPM×30 seconds), thereby obtaining a uniform sealing layer with a thickness of about 40 μm. The hot melt sheet member for forming the space below the diaphragm 1 (movable part) and the stainless steel (SUS) member having flow path through which the piston (transmission mechanism) 2 passes were heated in a superimposed state to about 140° C. and held for several seconds to be adhered to each other.

A member having the support portion 5 and the valve body portion 4 can be produced by mechanical processing or etching processing of a stainless steel body.

This member was obtained by etching a 200 μm thick stainless steel (SUS) member. The thickness of the support portion 5 was 50 μm.

By stacking the above-mentioned members, the pressure reducing valve of this embodiment can be realized by mechanical processing.

In the production process of this pressure reducing valve, two-stage etching of a stainless steel body is frequently employed. The two-stage etching is accurately and easily performed by forming different masks on the front surface and the rear surface and by carrying out etching for the both surfaces.

In the pressure reducing valve produced as described above, when the atmospheric pressure is about 1 atm, the secondary pressure is about 0.8 atm (absolute pressure).

Further, the pressure reducing valve produced as described above has leakage characteristics of 0.1 sccm or less and is not damaged even if the secondary pressure is increased up to 5 atm (absolute pressure).

In this embodiment, a hot melt sheet is used for adhesion. This method is excellent in control of thickness or positioning. In addition to the method, a method of applying another adhesive or a method of utilizing diffusion bonding of metal is also effective.

Further, because each member is in the form of a sheet, etching and pressing are suitable for processing of a metal member, and die cutting and injection molding are suitable for processing of a resin member.

Further, members produced by utilizing semiconductor processing technology described in the following embodiments can be used for a part or all of the members described in this embodiment.

### Second Embodiment

In Second Embodiment, a first method of producing, using semiconductor processing technology, the compact pressure reducing valve having the structure of the above-mentioned First Embodiment will be described.

The compact pressure reducing valve produced according to this embodiment has a structure such that the piston (transmission mechanism) is integrally formed with the valve body portion as shown in FIG. 6 and is separated from a movable part (diaphragm).

The typical dimension of each part of the compact pressure reducing valve produced in this embodiment can be set as follows, but can be changed according to designs.

The diaphragm (movable part) can be adjusted to be 3.6 mm in diameter and 40 μm in thickness.

The piston (transmission mechanism) can be adjusted to be 260 μm in diameter and 200 to 400 μm in length.

The flow path through which the piston passes can be adjusted to be 400 μm in diameter.

The projection portion can be adjusted to be 20 μm in width and 10 μm in height, the sealing layer can be adjusted to be 5 μm in thickness, and the valve body portion can be adjusted to be 1000 μm in diameter and 200 μm in thickness.

The support portion can be adjusted to be 1000 μm in length, 200 μm in width, and 10 μm in thickness.

Next, a method of producing the compact pressure reducing valve in this embodiment will be described.

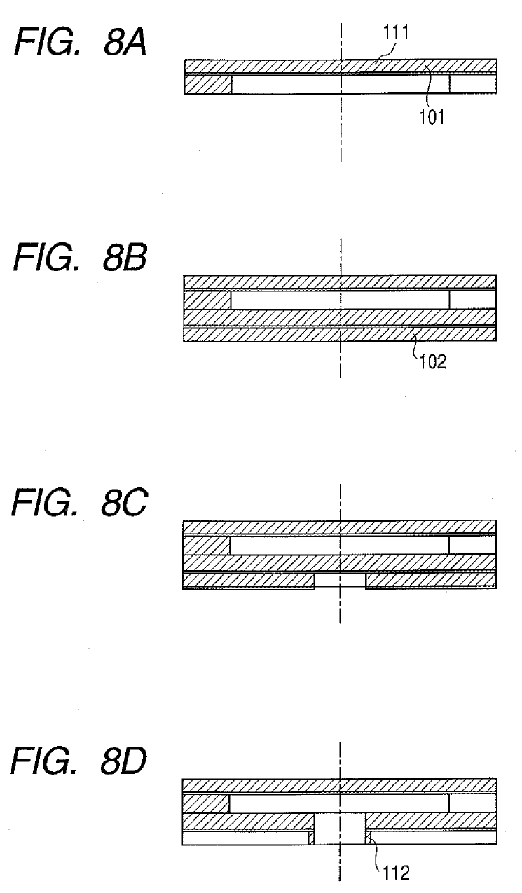

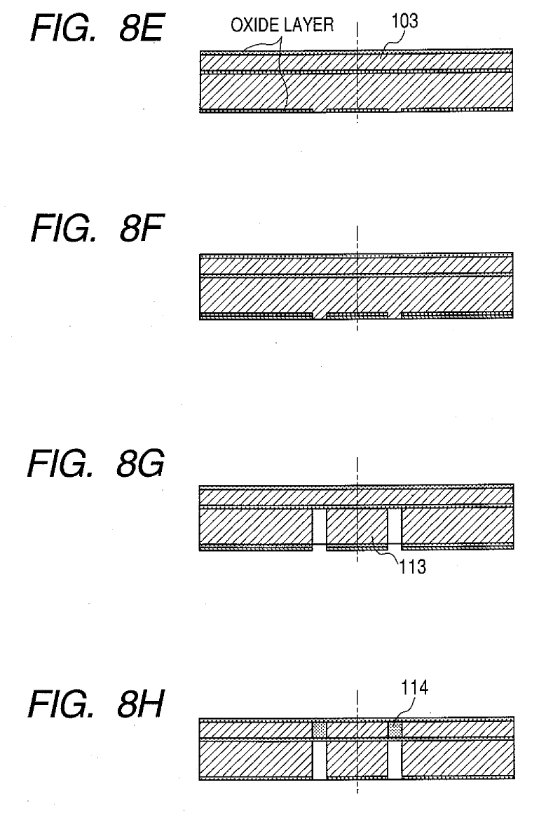

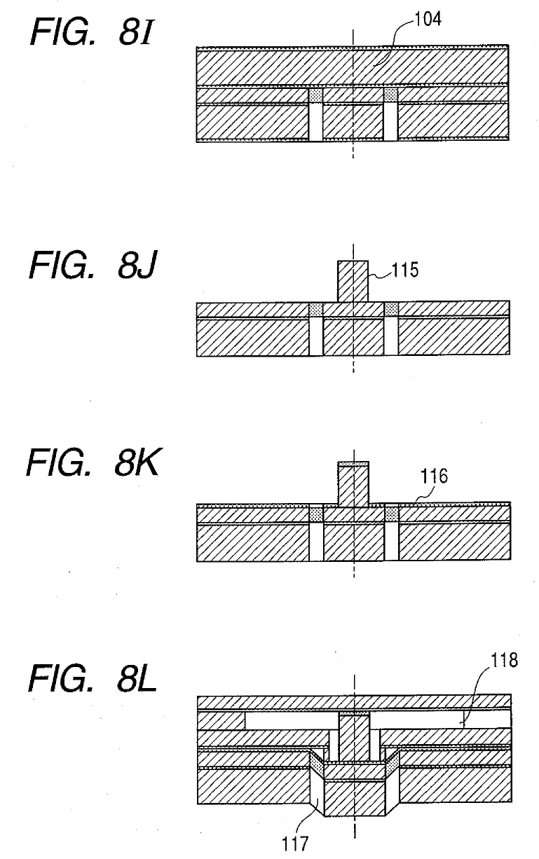

FIGS. 8A, 8B, 8C, 8D, 8E, 8F, 8G, 8H, 8I, 8J, 8K and 8L illustrate steps of the production procedure of the first production method of producing the compact pressure reducing valve.

First, a first step shown in FIG. 8A is a step of producing diaphragm (movable part) on a first silicon wafer 101.

A silicon wafer having one surface thereof polished may be used for the wafer. However, it is desirable to use a silicon wafer having both surfaces thereof polished.

Further, in an etching step below, in order to control the etching depth, it is desirable to use a silicon-on-insulator (SOI) wafer.

For the silicon wafer, a silicon wafer having a 200 μm thick handle layer, a 1 μm thick oxide layer (BOX layer), and a 40 μm thick device layer can be used.

An etching mask is produced on the first wafer 101.

Etching is performed by about 200 μm in depth using ICP-RIE (reactive ion etching).

At that time, a thick photoresist film with a thickness of 1 μm or more; a metal film such as of aluminum; or a silicon oxide layer formed by thermally oxidize the wafer surface can be used for the mask. In the case of using a silicon oxide layer for the mask, hydrogen and oxygen are flowed at predetermined flow rates in a furnace heated to about 1000° C. to thereby form an oxide layer on the wafer surface.

Next, photoresist is spin coated on the wafer surface, followed by pre-baking and exposure.

Further, development and post-baking are performed. Using the photoresist as the mask, the oxide layer is etched with hydrofluoric acid.

Using the mask thus obtained, a diaphragm (movable part) 111 is formed by ICP-RIE (reactive ion etching)

The etching depth may be controlled by adjusting the etching time, or an oxide layer (BOX layer) of an SOI wafer may be used as an etch stop layer.

After etching, the silicon oxide layer used for the mask is removed by hydrofluoric acid.

A second step shown in FIG. 8B is a direct-bonding step of a wafer.

In this step, first, a surface of another silicon wafer (second silicon wafer) 102 is thermally oxidized.

It is desirable to use a silicone wafer having both surfaces thereof polished for the second silicon wafer.

Further, in an etching step below, in order to control the depth of a projection portion of a valve seat portion 112, it is desirable to use a silicon-on-insulator (SOI) wafer.

For the silicon wafer, a silicon wafer having a 200 μm thick handle layer, a 1 μm thick oxide layer (BOX layer), and 5 μm thick device layer can be used.

The thermal oxidation process is the same as in the first step.

Next, the first wafer 101 and the second wafer 102 are washed with SPM (washed in a mixed liquid of hydrogen peroxide solution and sulfuric acid heated at 80° C.), and then washed with dilute hydrofluoric acid.

The first wafer 101 and the second wafer 102 are superimposed on each other, and the sample is heated to 1100° C. in 3 hours while pressurized at about 1500 N and held at that temperature for 4 hours, and is then naturally cooled to perform annealing.

A third step shown in FIG. 8C is a step of forming the flow path for allowing the piston (transmission mechanism) to pass therethrough.

In order to perform two-stage etching in this step and the subsequent step, a mask with a two-layer structure having a silicon oxide layer and a photoresist layer is produced.

First, a photoresist is spin coated on the rear surface, followed by pre-baking and exposure, and then patterning for producing the valve seat portion 112 is performed.

Further, development and post-baking are performed.

Using the photoresist as the mask, an oxide layer is etched by hydrofluoric acid.

Further, a mask for forming the flow path is patterned. More specifically, a photoresist is spin coated on the rear surface, followed by pre-baking, exposure, development, and post-baking.

Then, the flow path is formed by ICP-RIE (reactive ion etching).

When an SOI wafer is used, after etching is performed up to the middle oxide layer, the oxide layer is removed with hydrofluoric acid. The photoresist used for the mask is stripped with acetone.

A fourth step shown in FIG. 8D is a step of forming the valve seat portion 112 by ICP-RIE (reactive ion etching) using the mask for forming the valve seat portion 112 produced in the previous step.

In this step, when an SOI wafer is used, a middle oxide layer can be used as an etch stop layer, the height of the projection portion of the valve seat portion can be precisely adjusted, and the front surface after etching can be kept flat.

After etching, the silicon oxide layer used for the mask is removed with hydrofluoric acid. In this embodiment, the photoresist and the silicon oxide layer were used as a two-stage mask. However, this process can be performed by using silicon oxide layers having different thicknesses, or using an aluminum layer.

A fifth step shown in FIG. 8E is a step of producing a mask for forming a valve body portion 113 using a third wafer 103.

A silicon wafer having one surface thereof polished may also be used for the wafer. However, it is desirable to use a silicon wafer having both surfaces thereof polished.

Further, in an etching step below, in order to control the etching depth, it is desirable to use a silicon-on-insulator (SOI) wafer.

For the silicon wafer, a silicon wafer having a 200 μm thick handle layer, a 1 μm thick oxide layer (BOX layer), and a 10 μm thick device layer can be used.

First, the third silicon wafer 103 is thermally oxidized. The thermal oxidization is performed by placing the third silicon wafer 103 in a furnace and flowing hydrogen and oxygen at predetermined flow rates in the furnace heated at about 1000° C.

Next, the front surface oxide layer is protected by a photoresist, and then the oxide layer on the rear surface is patterned.

A photoresist is spin coated on the rear surface of the wafer, followed by pre-baking and exposure. Further, development and post-baking are performed. Using the photoresist as a mask, the oxide layer is etched with hydrofluoric acid, thereby performing patterning for forming the valve seat portion.

After the patterning, the photoresist on each of the front surface and rear surface is stripped with acetone.

A sixth step shown in FIG. 8F is a step of producing a mask for forming a support portion 114.

First, the oxide layer on the rear surface is protected by a photoresist, and then the oxide layer on the front surface is patterned.

The photoresist is spin coated on the front surface of the wafer, followed by pre-baking and exposure. Further, development and post-baking are performed. Using the photoresist as a mask, the oxide layer is etched with hydrofluoric acid, thereby performing patterning for forming the valve seat portion.

After the patterning, the photoresist on the front surface and rear surface are stripped with acetone.

A seventh step shown in FIG. 8G is a step of forming a valve body portion.

The rear surface of the wafer is etched by ICP-RIE (reactive ion etching).

The etching depth may be controlled by adjusting the etching time, or an oxide layer (BOX layer) of an SOI wafer may be used as an etch stop layer.

An eighth step shown in FIG. 8H is a step of forming a support portion.

A wafer surface is etched by ICP-RIE (reactive ion etching).

When an SOI wafer is used, the thickness of a support portion can be precisely controlled at this time. Therefore, a support portion with less spring constant error can be obtained.

After the etching, the oxide layer used for the mask is removed with hydrofluoric acid.

A ninth step shown in FIG. 8I is a step of bonding a fourth wafer 104 to the third wafer 103.

It is desirable to use a wafer having both surfaces thereof polished. The thickness of the wafer is selected in accordance with the height of the piston (transmission mechanism), and a 400 μm thick piston can be used.

The surface of the fourth wafer 104 is oxidized by thermal oxidation in advance.

Next, the third wafer 103 and the fourth wafer 104 are washed with SPM (washed in a mixed liquid of hydrogen peroxide solution and sulfuric acid heated at 80° C.), and then washed with dilute hydrofluoric acid.

The third wafer 103 and the fourth wafer 104 are superimposed on each other, and the sample is heated to 1100° C. in 3 hours while pressurized at about 1500 N and held for 4 hours at that temperature, and is then naturally cooled to be annealed.

A tenth step shown in FIG. 8J is a step of forming a transmission mechanism 115.

First, an etching mask is patterned. The silicon oxide layer on the wafer surface is used for the mask.

Next, etching is performed by ICP-RIE (reactive ion etching), and a transmission mechanism is formed. Etching stops at the silicon oxide layer of a bonding surface.

An eleventh step shown in FIG. 8K is a step of coating a sealing surface. As shown in FIG. 8K, the coating may be performed either on the valve body portion side or on the valve seat portion side.

Examples of the coating material include Parylene, CYTOP (trade name; manufactured by Asahi Glass), PTFE (polytetrafluoroethylene), polyimide, etc.

Parylene and PTFE can be applied by evaporation and CYTOP (trade name; Asahi Glass) and polyimide can be applied by spin coating. In addition, spray coating can also be used.

A twelfth step shown in FIG. 8L is an assembling step.

A compact pressure reducing valve is completed by stacking the member having the diaphragm (movable part) 111 and the valve seat portion 112 which was produced by the first to fourth steps, and the member having the transmission mechanism 115 and the valve body portion 113 which was produced by the fifth to eleventh steps.

In this embodiment, the bonding was performed using silicon diffusion bonding technology. However, the pressure reducing valve produced in this embodiment does not require high strength for bonding of the piston (transmission mechanism).

Therefore, a method of forming metal films on bonding surfaces, and then bonding the metals to each other, a method using an adhesive, and the like can also be used.

### Third Embodiment

In Third Embodiment, a second method of producing, using semiconductor processing technology, a compact pressure reducing valve having the structure of the above-mentioned First Embodiment will be described.

The compact pressure reducing valve produced according to this embodiment has a structure such that the piston (transmission mechanism) is integrally formed with the diaphragm (movable part) as shown in FIG. 1, and is separated from the valve body portion.

Compared with Second Embodiment, because the number of bonding steps is reduced from two to one, the yield and throughput can be improved.

Further, because the number of wafers can be reduced from four to three, the production cost can also be reduced.

As described below, the second production method is also advantageous in that the shape of a diaphragm (movable part) is formed into a doughnut shape which has a support portion at the center, thereby optimizing the rigidity of the diaphragm (movable part).

The typical dimension of each part of the compact pressure reducing valve produced in this embodiment can be set as follows, but can be changed according to designs.

The diaphragm (movable part) can be adjusted to be 3.6 mm in diameter and 40 μm in thickness.

The piston (transmission mechanism) can be adjusted to be 260 μm in diameter and 200 to 400 μm in length.

The flow path for allowing the piston to pass therethrough can be adjusted to be 400 μm in diameter.

The projection portion can be adjusted to be 20 μm in width and 10 μm in height, the sealing layer can be adjusted to be 5 μm in thickness, and the valve body portion can be adjusted to be 1000 μm in diameter and 200 μm in thickness.

The support portion can be adjusted to be 1000 μm in length, 200 μm in width, and 10 μm in thickness.

Next, the method of producing the compact pressure reducing valve in this embodiment will be described.

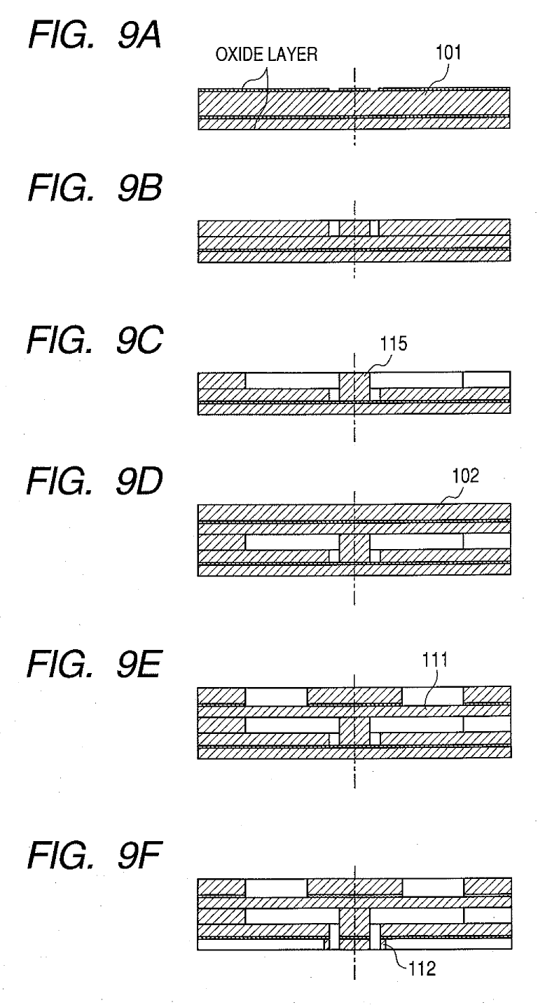

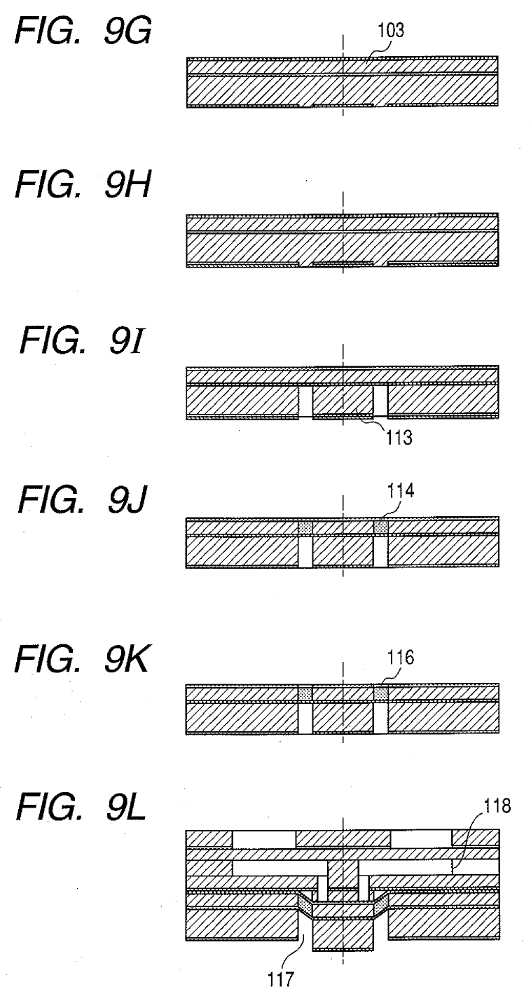

FIGS. 9A, 9B, 9C, 9D, 9E, 9F, 9G, 9H, 9I, 9J, 9K and 9L illustrate steps of the production procedure of the second method of producing the compact pressure reducing valve in the above-mentioned producing method.

First, a first step shown in FIG. 9A is a mask patterning step for etching.

For the first silicon wafer 101, a silicon wafer having one surface thereof polished may also be used, but it is desirable to use a silicon wafer having both surfaces polished.

In an etching step described below, in order to control the etching depth, it is desirable to use a silicon-on-insulator (SOI) wafer.

For the silicon wafer, a silicon wafer having a 300 μm thick handle layer, a 1 μm thick oxide layer (BOX layer), and a 5 μm thick device layer is reversed and used in such a manner that the handle layer is positioned at the top in the figures.

For use as an etching mask, the surfaces of the first wafer 101 are thermally oxidized.

The first wafer 101 is placed in a furnace and hydrogen and oxygen are flowed at predetermined flow rates in the furnace heated to about 1000° C. to thereby form an oxide layer on the wafer surfaces.

Next, in order to perform two-stage etching in this process and the subsequent step, a mask with a two-layer structure having a silicon oxide layer and a photoresist layer is produced.

The photoresist is spin coated, followed by pre-baking and exposure, and is then patterned for producing a flow path under the diaphragm (movable part) is performed.

Further, development and post-baking are performed. The oxide layer is etched with hydrofluoric acid using the photoresist as a mask. Further, a mask for forming the transmission mechanism 115 is patterned.

More specifically, the photoresist is spin coated, pre-baked, exposed, developed, and post-baked.

In this embodiment, the photoresist and the silicon oxide layer were used as a two-stage mask. However, this process can be performed by using silicon oxide layers having different thicknesses, or using an aluminum layer.

A second step shown in FIG. 9B is a step of forming a piston (transmission mechanism) by ICP-RIE (reactive ion etching).

The etching depth is controlled by adjusting the etching time, and etching of about 150 μm is performed. Finally, the photoresist mask is removed with acetone.

A third step shown in FIG. 9C is a step of producing a flow path positioned under the diaphragm (movable part).

A wafer is etched by CP-RIE (reactive ion etching).

The etching depth may be controlled by adjusting the etching time, or an oxide layer (BOX layer) of an SOI wafer may be used as an etch stop layer as shown in figure. The silicon oxide layer used for the mask is removed by hydrofluoric acid.

A fourth step shown in FIG. 9D is a direct bonding step of a wafer. It is desirable to use a silicon wafer having both surfaces polished for the second silicon wafer.

Further, in an etching step below, in order to control the height of the valve seat portion 112, it is desirable to use an SOI (silicon-on-insulator) wafer. A silicon wafer with a 200 μm thick handle layer, a 1 μm thick oxide layer (BOX layer), and a 40 μm thick device layer is mentioned as an example of the silicon wafer, and the device layer is used as the diaphragm (movable part). When using a silicon oxide as an etching mask in subsequent etching, thermal oxidation is performed similarly as in the first step.

Next, the first wafer 101 and the second wafer 102 are washed with SPM (washed in a mixed liquid of hydrogen peroxide solution and sulfuric acid heated at 80° C.), and then washed with dilute hydrofluoric acid.

The first wafer 101 and the second wafer 102 are superimposed on each other, and the sample is heated to 1100° C. in 3 hours while pressurized at about 1500 N and held at that temperature for 4 hours, and is then naturally cooled to be annealed.

A fifth step shown in FIG. 9E is a step of producing the diaphragm (movable part).

A wafer is etched by ICP-RIE (reactive ion etching).

The etching depth may be controlled by adjusting the etching time, or an oxide layer (BOX layer) of an SOI wafer may be used as an etch stop layer as shown in the figure.

The shape of the diaphragm (movable part) may be circular. Alternatively, as shown in the figures, a doughnut-shaped diaphragm or a diaphragm with a beam may be used.

A sixth step shown in FIG. 9F is a step for forming the valve seat portion 112.

For a mask, besides a thick film photoresist, a silicon oxide layer, aluminum, etc., can be used.

A photoresist is spin coated on a wafer surface, followed by pre-baking and exposure. When using a material other than photoresist for the mask, a mask layer is patterned by an etchant.

Etching is performed by ICP-RIE (reactive ion etching) to thereby form the valve seat portion 112.

When an SOI wafer is used for the first wafer 101, a middle oxide layer can be used as an etch stop layer, the height of the projection portion of the valve seat portion can be precisely adjusted, and the front surface after etching can be kept flat.

The mask is removed after etching.

A seventh step shown in FIG. 9G is a mask patterning step for etching using the third silicon wafer 103.

For the third silicon wafer 103, a silicon wafer having one surface thereof polished may also be used, but it is desirable to use a silicon wafer having both surfaces thereof polished.

Further, in an etching step described below, in order to control the etching depth, it is desirable to use a silicon-on-insulator (SOI) wafer.

For the silicon wafer, a silicon wafer having a 200 μm thick handle layer, a 1 μm thick oxide layer (BOX layer), and a 10 μm thick device layer can be used.

For use as an etching mask, the surface of the third silicon wafer 103 is thermally oxidized.

The third silicon wafer 103 is placed in a furnace and hydrogen and oxygen are flowed at predetermined flow rates in the furnace heated to about 1000° C. to thereby form an oxide layer on the wafer surface.

Next, the front surface of the wafer is protected by a photoresist, and then patterning is performed for forming a valve body portion on the rear surface of the wafer. The photoresist is spin coated, pre-baked, and exposed.

Further, development and post-baking are performed. The oxide layer is etched with hydrofluoric acid while using the photoresist as the mask.

The photoresist on each of the front surface and the rear surface is removed with acetone. In this process, it is possible to use a photoresist and aluminum other than the silicon oxide for the mask.

An eighth step shown in FIG. 9H is a step of patterning a mask for forming the support portion 114.

The rear surface of the wafer is protected by a photoresist, and then patterning is performed for forming a support portion on the rear surface of the wafer. The photoresist is spin coated, pre-baked, and exposed. Further, development and post-baking are performed. The oxide layer is etched with hydrofluoric acid while using the photoresist as the mask. The photoresist on each of the front surface and the rear surface is removed with acetone.

A ninth step shown in FIG. 9I is a step of forming the valve body portion 113.

The rear surface of a wafer is etched by ICP-RIE (reactive ion etching). The etching depth may be controlled by adjusting the etching time, or an oxide layer (BOX layer) of an SOI wafer may be used as an etch stop layer.

A tenth step shown in FIG. 9J is a step of forming a support portion.

The front surface of a wafer is etched by ICP-RIE (reactive ion etching).

When an SOI wafer is used, the thickness of a support portion can be precisely controlled at this time, so that a support portion with less spring constant error can be obtained.

After etching, the oxide layer used for the mask is removed by hydrofluoric acid.

An eleventh step shown in FIG. 9K is a step of coating a sealing surface.

As shown in FIG. 9K, the coating may be performed either on the valve body portion side or on the valve seat portion side.

Examples of the coating material include Parylene, CYTOP (trade name; manufactured by Asahi Glass), polytetrafluoroethylene (PTFE), polyimide, etc.

Parylene and PTFE can be applied by vapor deposition and CYTOP (trade name; manufactured by Asahi Glass) and polyimide can be applied by spin coating. In addition, spray coating can also be used.

A twelfth step shown in FIG. 9L is an assembling step.

A compact pressure reducing valve is completed by stacking the member having the diaphragm (movable part) 111 and the valve seat portion 112 which was produced by the first to sixth steps, and the member having the valve body portion 113 which was produced by the seventh to eleventh steps.

In this embodiment, bonding is performed using silicon diffusion bonding technology. However, the pressure reducing valve produced in this embodiment does not require high strength for bonding of the piston (transmission mechanism).

Therefore, a method of forming metal films on bonding surfaces and then bonding metals with each other, a method using an adhesive, and the like can also be used.

### Fourth Embodiment

In Fourth Embodiment, a third method of producing, using semiconductor processing technology, the compact pressure reducing valve having the structure of the above-mentioned First Embodiment will be described.

The compact pressure reducing valve produced according to this embodiment has a structure such that the transmission mechanism (piston) is integrally formed with the diaphragm (movable part) as shown in FIG. 1, and is separated from the valve body portion.

Compared with Second and Third Embodiments, in the third method, a bonding step is not required. In the third method, three parts are separately produced, and finally the three parts are combined.

Therefore, the respective production process can be separately performed simultaneously, and when a defective unit is produced, only a defective part can be exchanged. Thus, the third method is advantageous in that the yield can be improved.

The typical dimension of each part of the compact pressure reducing valve produced in this embodiment can be set as follows, but can be changed according to designs.

The diaphragm (movable part) can be adjusted to be 3.6 mm in diameter and 40 μm in thickness.

The piston (transmission mechanism) can be adjusted to be 260 μm in diameter and 200 to 400 μm in length.

The piston passing flow path can be adjusted to be 400 μm in diameter.

The projection portion can be adjusted to be 20 μm in width and 10 μm in height, the sealing layer can be adjusted to be 5 μm in thickness, and the valve body portion can be adjusted to be 1000 μm in diameter and 200 μm in thickness.

The support portion can be adjusted to be 1000 μm in length, 200 μm in width, and 10 μm in thickness.

Hereinafter, a method of producing a compact pressure reducing valve in this embodiment will be described.

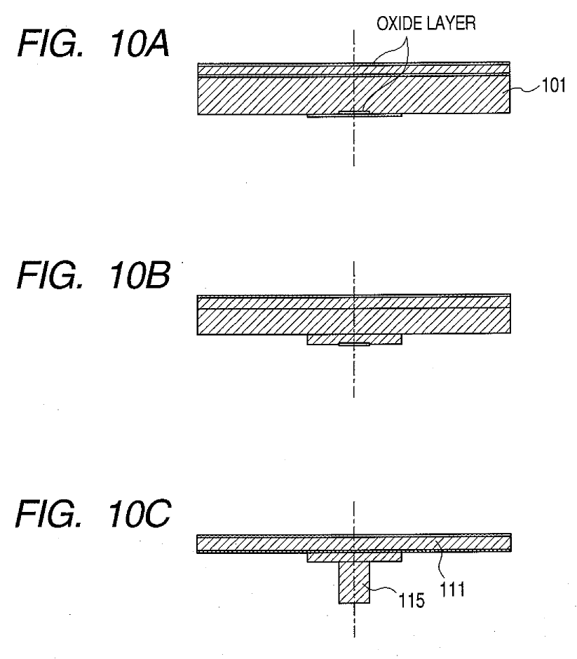

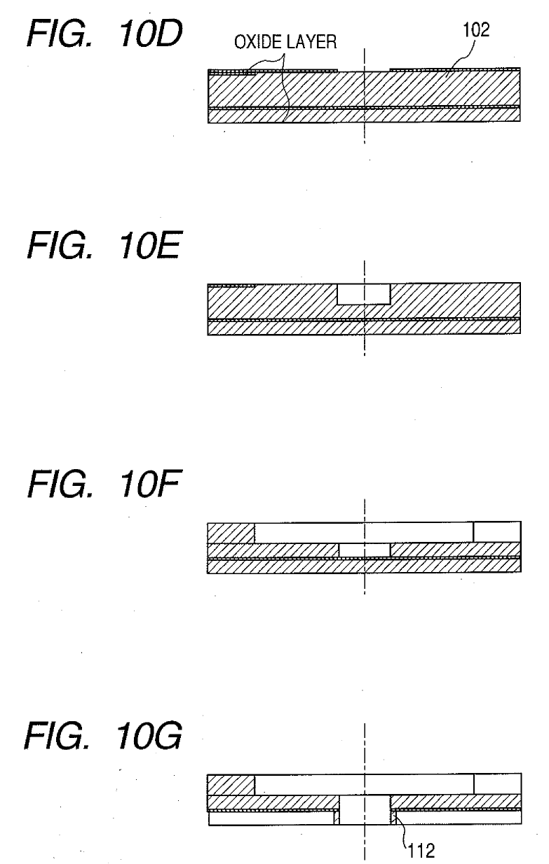

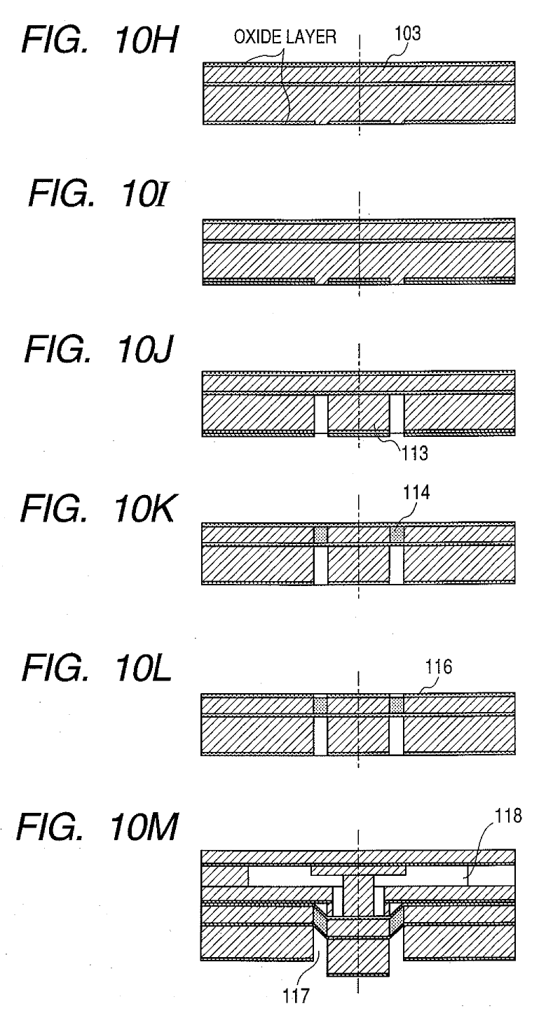

FIGS. 10A, 10B, 10C, 10D, 10E, 10F, 10G, 10H, 10I, 10J, 10K, 10L and 10M illustrate steps of the production procedures of the third method of producing the compact pressure reducing valve in this embodiment.

A first step shown in FIG. 10A is a mask patterning step for etching. For the first silicon wafer 101, a silicon wafer having one surface thereof polished may also be used, but it is desirable to use a silicon wafer having both surfaces thereof polished.

Further, in an etching step below, in order to control the etching depth, it is desirable to use a silicon-on-insulator (SOI) wafer.

For the silicon wafer, a silicon wafer having a 500 μm thick handle layer, a 1 μm thick oxide layer (BOX layer), and a 40 μm thick device layer can be used.

For use as an etching mask, the surfaces of the first silicon wafer 101 are thermally oxidized. By placing the silicon wafer in a furnace and flowing hydrogen and oxygen at predetermined flow rates in the furnace heated to about 1000° C. to thereby form an oxide layer on the wafer surface.

Next, in order to perform two-stage etching in this step and the subsequent step, a mask with a two-layer structure having a silicon oxide layer and a photoresist layer is produced.

First, the front surface of the wafer is protected by a photoresist. Next, a photoresist is spin coated on the rear surface of the wafer, pre-baked, and exposed. Then, patterning for producing a flow path under the diaphragm (movable part) is performed.

Further, development and post-baking are performed. The oxide layer is etched with hydrofluoric acid using the photoresist as a mask.

Further, a mask for forming a support portion between the transmission mechanism 115 and the movable part 111 is patterned.

More specifically, the photoresist is spin coated, pre-baked, exposed, developed, and post-baked. In this embodiment, the photoresist and the silicon oxide layer were used as a two-stage mask. However, this process can be performed by using silicon oxide layers having different thicknesses, or using an aluminum layer.

A second step shown in FIG. 10B is a step of forming a support portion of the transmission mechanism by ICP-RIE (reactive ion etching).

The etching depth is controlled by adjusting the etching time, and etching of about 150 μm is performed. Finally, the photoresist mask is removed with acetone.

A third step shown in FIG. 10C is a step of producing the diaphragm (movable part) 111 and the transmission mechanism 115.

A wafer is etched by CP-RIE (reactive ion etching).

The etching depth may be controlled by adjusting the etching time, or an oxide layer (BOX layer) of an SOI wafer may be used as an etch stop layer as shown in figure. The silicon oxide layer used for the mask is removed with hydrofluoric acid.

As described above, in this embodiment, two-stage etching using a two-stage mask was performed in order to form a support portion between the transmission mechanism and the diaphragm (movable part).

However, depending on the required spring constant, the support portion is not required. In such a case, a single-layer mask suffices as the mask used in this embodiment and the second step is not required.

A fourth step shown in FIG. 10D is a mask patterning step for etching.

For a second silicon wafer 102, it is desirable to use a silicon wafer having both surfaces thereof polished. Further, in an etching step described below, in order to control the etching depth, it is desirable to use a silicon-on-insulator (SOI) wafer.

For the silicon wafer, a silicon wafer having a 500 μm thick handle layer, a 1 μm thick oxide layer (BOX layer), and a 5 μm thick device layer is reversed in such a manner that the handle layer is positioned at the top in the figure. For use as an etching mask, the surfaces of the second silicon wafer 102 are thermally oxidized. By placing the second silicon wafer in a surface and flowing hydrogen and oxygen at predetermined flow rates in a furnace heated at about 1000° C. to thereby form an oxide layer on the wafer surface.

Next, in order to perform two-stage etching in this process and the subsequent step, a mask with a two-layer structure having a silicon oxide layer and a photoresist layer is produced.

First, the rear surface of the wafer is protected by a photoresist.

Next, a photoresist is spin coated on the front surface of the wafer, pre-baked, and exposed. Then, patterning for producing a flow path under the diaphragm (movable part) is performed.

Further, development and post-baking are performed. The oxide layer is etched with hydrofluoric acid using the photoresist as a mask.

Further, a mask for forming a flow path around the transmission mechanism 115 is patterned. More specifically, the photoresist is spin coated, pre-baked, exposed, developed, and post-baked. In this embodiment, the photoresist and the silicon oxide layer were used as a two-stage mask. However, this process can be performed by using silicon oxide layers with different thicknesses, or using an aluminum layer.

A fifth step shown in FIG. 10E is a step of producing the piston (transmission mechanism) by ICP-RIE (reactive ion etching).

The etching depth may be controlled by adjusting the etching time, and etching of about 200 μm is performed. Finally, the photoresist mask is removed with acetone.

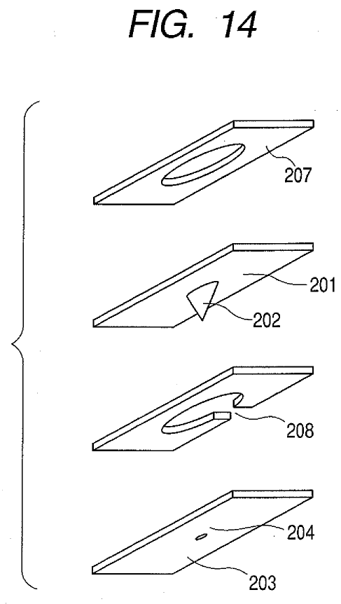

A sixth step shown in FIG. 14F is a step of producing a flow path below the diaphragm (movable part).

A wafer is etched by ICP-RIE (reactive ion etching). The etching depth may be controlled by adjusting the etching time, or an oxide layer (BOX layer) of an SOI wafer may be used as an etch stop layer as shown in figure.

A seventh step shown in FIG. 14G is a step of forming a valve seat portion 112.

A photoresist is spin coated on the rear surface of the wafer, pre-baked, and exposed. A silicon oxide layer is etched with hydrofluoric acid and patterned.

Etching is performed by ICP-RIE (reactive ion etching), to thereby form the valve seat portion 112.

When an SOI wafer is used for the first wafer 101, a middle oxide layer can be used as an etch stop layer, the height of the projection portion of the valve seat portion can be precisely adjusted, and the front surface after etching can be kept flat. After etching, the mask is removed with hydrofluoric acid.

The steps from an eighth step illustrated in FIG. 10H to a thirteenth step illustrated in FIG. 10M are the same as those of the seventh step to the twelfth step described in Third Embodiment.

### Fifth Embodiment

In Fifth Embodiment, a second structural example of a pressure reducing valve as the pressure control valve of the present invention will be described.

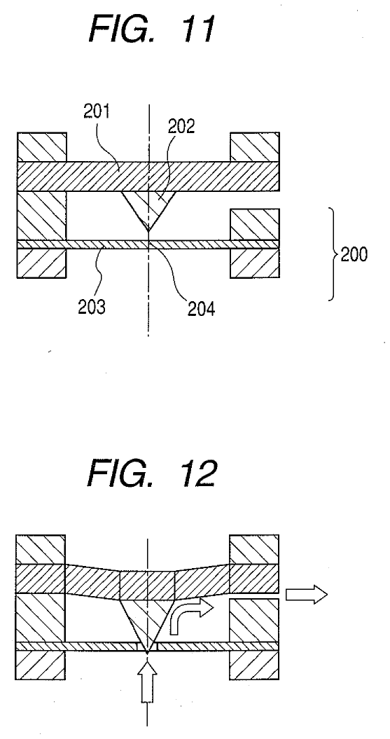

FIG. 11 is a schematic cross-sectional view illustrating the second structural example of the compact pressure reducing valve in this embodiment.

The pressure mechanism of this embodiment includes a diaphragm 201 which serves as a movable part, a piston 202 which is a transmission mechanism, and a valve part 200. The valve part 200 is formed of an elastic body and is provided with a through hole 204.

The through hole 204 is usually closed, and when the tip of the transmission mechanism 202 expands the through hole, the valve is opened.

The chip of the transmission mechanism may be in the form of a conical shape as shown in FIG. 11, and may have a groove portion such as a notch 205 on a side surface thereof as shown in FIG. 13.

Hereinafter, the operations of the pressure reducing valve of this embodiment will be described.

The pressure at a location above the diaphragm (movable part) 201 is defined as P₀, the primary pressure at upstream of the valve is defined as P₁, and the pressure at downstream of the valve is defined as P₂.

When P₂ is higher than P₀, because the diaphragm (movable part) 201 bends upward, and the through hole 204 is closed by the elasticity of the valve part 200, the valve is closed.

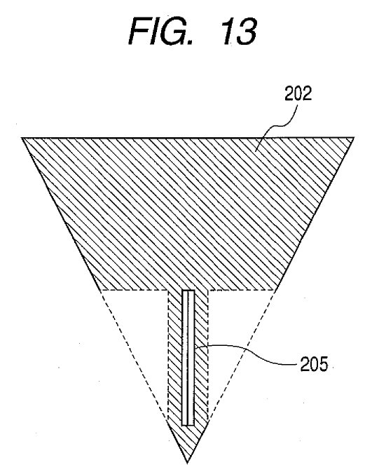

In contrast, when P₂ is lower than P₀, the diaphragm (movable part) 201 bends downward and the transmission mechanism 202 expands the through hole 204 of the valve part 200, so that the valve is opened as shown in FIG. 12.

Thereby, the pressure P₂ can be kept constant. The pressure at which the valve opens/closes and the flow rate can be optimally adjusted by adjusting the area and thickness of the diaphragm (movable part) 201, the length of the transmission mechanism 202, and the thickness and elasticity of the valve part 200.

The pressure reducing valve in this embodiment can be produced using mechanical processing technology as described below.

FIG. 14 is an exploded perspective view when the pressure reducing valve is viewed from the through hole side.

For the diaphragm (movable part) 201, metallic materials such as stainless steel, aluminum, or the like can be used besides elastic materials such as Viton (trade name; manufactured by DuPont) rubber, silicone rubber, etc.

When stainless steel is used as a material for the diaphragm 201, the transmission mechanism can be integrally formed by etching, cutting, etc.

For a material of the valve part 200, elastic materials such as Viton (trade name; manufactured by DuPont) rubber, silicone rubber, or the like can be used.

### Sixth Embodiment

In Sixth Embodiment, a third structural example of a pressure reducing valve as the pressure control valve of the present invention will be described.

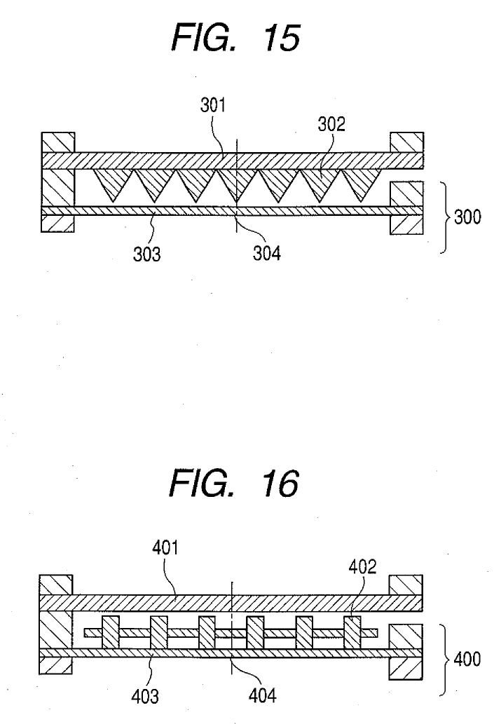

FIG. 15 is a schematic cross-sectional view illustrating the third structural example of the compact pressure reducing valve of this embodiment.

The pressure mechanism of this embodiment includes a diaphragm 301 which serves as a movable part, pistons 302 which are a transmission mechanism, and a valve part 300. The valve part 300 is formed of an elastic body and is provided with through holes 304.

The through hole 304 is usually closed, and when the tip of the transmission mechanism 302 expands the through hole, the valve is opened.

The transmission mechanism 302 includes a plurality of projection portions. The transmission mechanism may be produced by roughening the surface of the diaphragm (movable part).

Another form of this embodiment is illustrated in FIG. 16.

In this structural example, the transmission mechanism 402 is formed of a seat having an uneven (or irregular) shape on the surface thereof.

The transmission mechanism may be separated from the movable part 401.

Hereinafter, the operations of the pressure reducing valve of this embodiment will be described.

The pressure at a location above the diaphragm (movable part) 301, 401 is defined as P₀, the primary pressure at upstream of the valve is defined as P₁, and the pressure at downstream of the valve is defined as P₂. When P₂ is higher than P₀, because the diaphragm (movable part) 301, 401 bends upward, and the through holes 304, 404 are closed by the elasticity of the valve part 300, 400.

In contrast, when P₂ is lower than P₀, the diaphragm (movable part) 301, 401 bends downward and the transmission mechanism 302, 402 pushes the elastic member 303, 304 or the through holes 304, 404 of the valve part 300, 400.

This causes distortion, which then expands the through holes 304, 404, thereby opening the valve. Thereby, the pressure P₂ can be kept constant.

The pressure at which the valve opens/closes and flow rate can be optimally designed by adjusting the area and thickness of the diaphragm (movable part) 301, 401, the length of the transmission mechanism 302, 402, and the thickness and elasticity of the valve part 300, 400.

### Seventh Embodiment

In Seventh Embodiment, a fifth structural example of a pressure reducing valve as the pressure control valve of the present invention will be described.

A pressure reducing valve according to this embodiment can be produced similarly as in First Embodiment.

The fifth structure of the pressure reducing valve of this embodiment will be described.

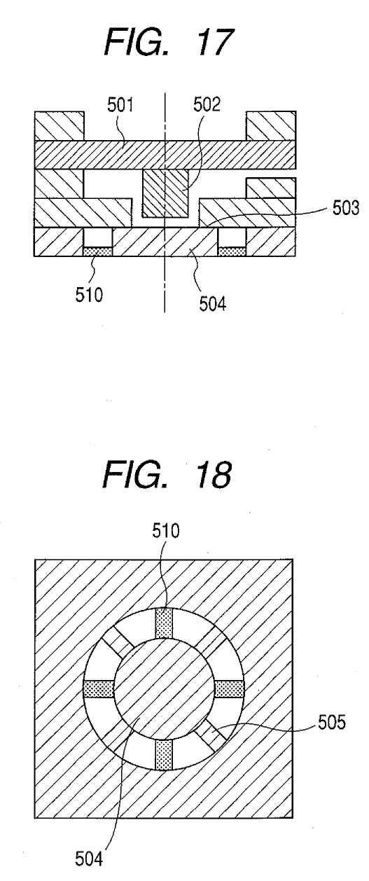

FIG. 17 is a schematic cross-sectional view illustrating the fifth structural example of the pressure reducing valve of this embodiment.

The pressure reducing valve of this embodiment includes a diaphragm 501 which serves as a movable part, a piston 502 which is a transmission mechanism, a valve seat portion 503 for forming a valve part, a valve body portion 504, a support portion 505 and a temperature-dependent displacing portion 510.

In particular, as shown in FIGS. 17 and 18, the valve body portion 504 is circumferentially supported by the support portion 505 and the temperature-dependent displacing portion 510.

As shown in FIG. 18, the support portion 505 is formed from a beam having elasticity.

The temperature-dependent displacing portion 510 is formed of a shape memory alloy such as titanium-nickel alloy.

The shape memory alloy of titanium-nickel alloy can also be formed using sputtering, and can be incorporated into the semiconductor process of First Embodiment.

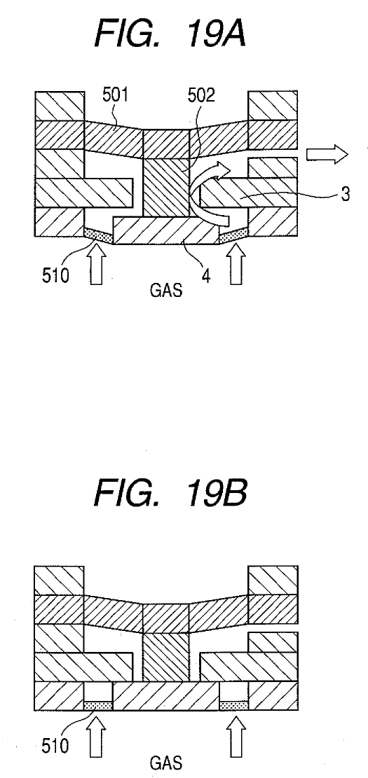

The temperature-dependent displacing portion 510 plastically deforms at normal temperatures and does not influence the spring property of the above-mentioned support portion 505, and thus functions as an ordinary pressure reducing valve (in a state where the temperature is less than a threshold temperature; FIG. 19A).

When the temperature around the pressure reducing valve abnormally rises to be higher than a given temperature (threshold temperature), the shape memory alloy of the temperature-dependent displacing portion 510 is displaced in such a manner as to bend backward in the direction toward the valve seat portion 503 (upward direction in FIG. 19B), and the valve body portion 504 was pressed against the valve seat portion 503, whereby the valve is closed as shown in FIG. 19B.

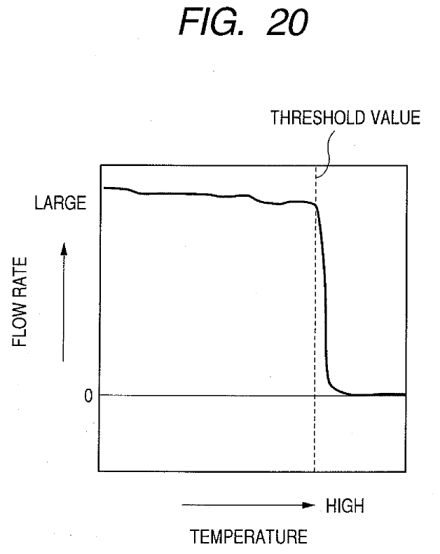

The flow rate of the pressure reducing valve at this time fluctuates as shown in FIG. 20.

The temperature-dependent displacing portion 510 does not function in the region where the temperature is less than a threshold value indicated by a dashed line. Therefore, a flow rate is generated while maintaining a secondary pressure similarly as in an ordinary pressure reducing valve.

Further, when the temperature rises beyond the threshold value, the shape memory alloy of the temperature-dependent displacing portion 510 functions to move the valve body portion 504 upward, whereby the valve is closed. Moreover, when the temperature is reduced below the threshold value, the temperature-dependent displacing portion 510 functions as an ordinary pressure reducing valve. Therefore, reversible utilization is made possible.

Thus, by providing the temperature-dependent displacing portion 510 formed of a shape memory alloy in a pressure reducing valve, when the temperature is lower than a threshold temperature, the valve can function as a pressure reducing valve, and when the temperature is higher than the threshold temperature, the valve can function as a cutoff valve. Therefore, the present invention can provide a valve mechanism with higher safety.

The above description has been made by taking, as an example, a case where a shape memory alloy is used as the temperature-dependent displacing portion 510. However, also in cases where other materials which are displaced depending on temperatures, such as a bimetal or the like are used, the similar effect can be achieved.

Further, the description has been made by also taking, as an example, a case where the support portion 505 and the temperature-dependent displacing portion 510 are separately disposed. However, for the support portion 505, a temperature-dependent displacing material may also be utilized which utilizes a metallic material having a spring property or the like.

### Eighth Embodiment

In Eighth Embodiment, there is described a compact polymer electrolyte fuel cell with a power generation amount within a range of from several milliwatts to several hundred watts which is mounted with a compact pressure reducing valve as the pressure control valve of the invention.

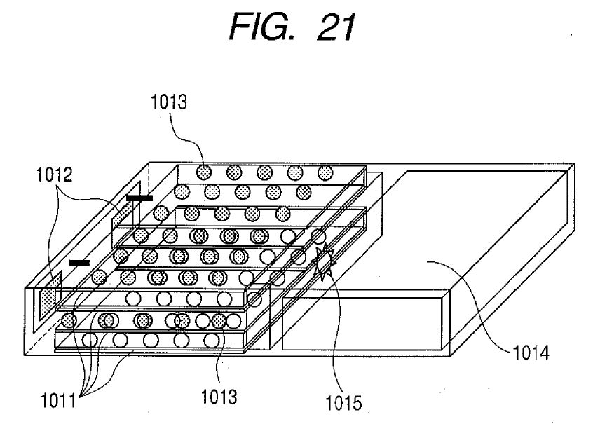

FIG. 21 is a schematic perspective view illustrating a fuel cell of this embodiment.

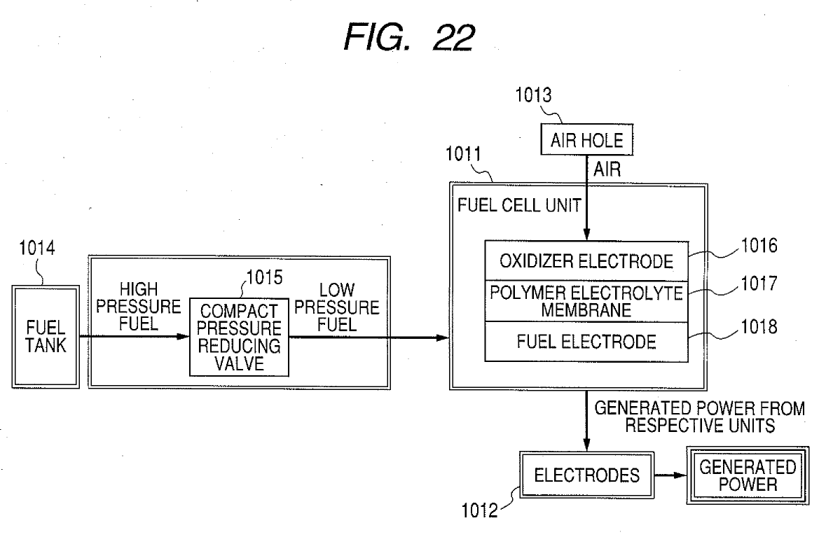

Further, FIG. 22 is a schematic diagram illustrating a system of the fuel cell of this embodiment.

The external dimension of the fuel cell is 50 mm×30 mm×10 mm, and is almost the same dimension as that of a lithium ion battery usually used in a compact digital camera.

As described above, because the fuel cell of this embodiment is compact and is integrally assembled, the shape thereof is easy to be incorporated into a portable device.

The fuel cell of this embodiment takes in oxygen as an oxidizer for use in a reaction from the outside air, so that air holes 1013 for taking in the outside air are provided on the upper surface, lower surface, and side surfaces.

Further, the air hole also serves to release the generated water as water vapor and to release the heat generated by a reaction to the outside.

The inside of the fuel cell is composed of a fuel cell unit 1011 including an oxidizer electrode 1016, a polymer electrolyte membrane 1017, a fuel electrode 1018; a fuel tank 1014 which stores fuel; and a compact pressure reducing valve 1015 in which the fuel tank is connected to the fuel electrode of each cell unit, thereby controlling the flow rate of the fuel.

Next, the fuel tank 1014 of this embodiment will be described.

The inside of the tank is filled with a hydrogen storage alloy which can occlude hydrogen. Based on the fact that the pressure resistance of a polymer electrolyte membrane for use in a fuel cell is 0.3 to 0.5 MPa, the differential pressure between the outside air and the inside of the tank needs to be equal to or less than 0.1 MPa.

LaNi₅ and the like are used as a hydrogen storage alloy having a hydrogen release pressure of 0.2 MPa at ordinary temperature.

When the volume of the fuel tank is half of the entire volume of the fuel cell; the tank wall thickness is 1 mm; and titanium is used as a material of the tank, the weight of the fuel tank is about 50 g and the volume of the fuel tank is 5.2 cm³.

When a hydrogen storage material having a hydrogen release pressure exceeding 0.2 MPa at ordinary temperature is placed in the tank, it is necessary to provide a compact pressure reducing valve 1015 between the fuel tank 1014 and the fuel electrode 1018 for reducing the pressure.

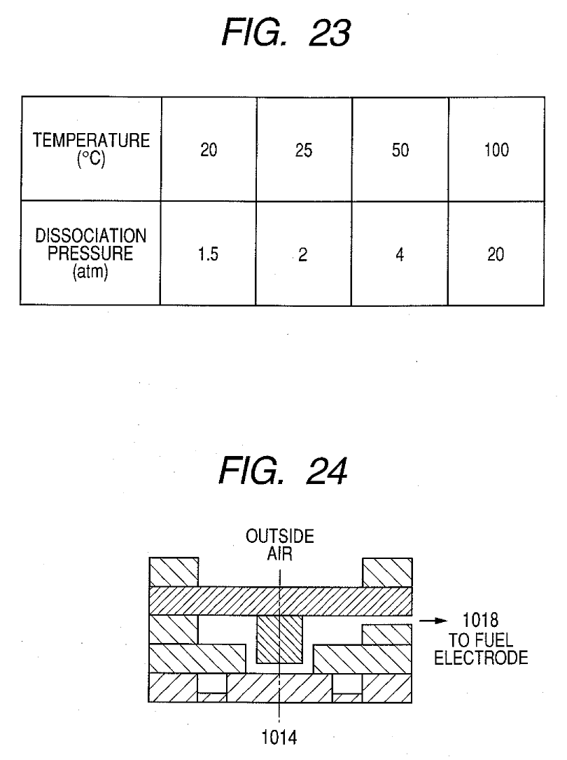

LaNi₅ can absorb/desorb 1.1 wt % of hydrogen per unit weight. The dissociation pressures at various temperatures of LaNi₅ are shown in FIG. 23.

The hydrogen stored in the tank is depressurized with the compact pressure reducing valve 1015, and is supplied to the fuel electrode 1018. The outside air is supplied through the air holes 1013 to the oxidizer electrode 1016. The electricity generated by the fuel cell units is supplied to a compact electrical device through the electrodes 1012.

FIG. 24 is a cross-sectional view illustrating the positional relationship when the compact pressure reducing valve of this embodiment is mounted on a fuel cell.

The primary side of the compact pressure reducing valve is connected to the fuel tank 1014.

An exit flow path is connected to the fuel electrode and the side opposite to the exit flow path side of the diaphragm (movable part) is connected to the oxidizer electrode (outside air).

The size of the entire valve is about 10 mm×10 mm×1 mm. As described above, by realizing such a compact valve mechanism, a mechanism for controlling a fuel flow rate can be incorporated into a compact fuel cell.

Hereinafter, an open/closing operation of the valve involved with the power generation of the fuel cell will be described.

While the power generation is stopped, the compact pressure reducing valve 1015 remains closed. When power generation is started, the fuel in the fuel electrode chamber is consumed, whereby the pressure of the fuel in the fuel electrode chamber decreases.

The diaphragm (movable part) bends toward the fuel electrode chamber by a differential pressure between the atmospheric pressure and the pressure in the fuel electrode chamber, whereby the valve body portion, which is directly connected to the diaphragm (movable part) by a valve shaft, is pressed down to thereby open the valve.

Thus, the fuel is supplied to the fuel electrode chamber by the fuel tank 1014. When the pressure in the fuel electrode chamber is restored, the diaphragm (movable part) is pushed up to thereby close the compact pressure reducing valve 1015.

According to the structures and production methods described in the above embodiments, it is possible to achieve size reduction of a pressure reducing valve and to impart excellent sealing property and durability to the pressure reducing valve.

By using such a compact pressure reducing valve for controlling a compact fuel cell, a fuel cell system can be reduced in size.

Further, according to the above-mentioned Seventh Embodiment, in addition to the function of an ordinary pressure reducing valve, the pressure reducing valve can be imparted with the function as a temperature-dependent cutoff valve by the concomitant use of the member which is displaced depending on temperatures.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-232754, filed Aug. 29, 2006, which is hereby incorporated by reference herein in its entirety.

1. A pressure control valve, comprising:
a movable part which operates by a differential pressure;
a valve part; and
a transmission mechanism for transmitting an action of the movable part to the valve part,
wherein either one of the movable part and the valve part is separated from the transmission mechanism.

2. The pressure control valve according to claim 1, wherein the movable part is a diaphragm.

3. The pressure control valve according to claim 1, wherein the valve part comprises a valve seat portion, a valve body portion, and a support portion for supporting the valve body portion, and wherein the support portion supports the valve body portion such that a gap is formed or eliminated between the valve body portion and the valve seat portion according to the action of the movable part transmitted by the transmission mechanism.

4. The pressure control valve according to claim 3, wherein the support portion for supporting the valve body portion comprises an elastic body for supporting the valve body portion provided on a flat plane which is perpendicular to a direction of an action of the transmission mechanism and includes the valve body portion.

5. The pressure control valve according to claim 4, wherein the support portion for supporting the valve body portion comprises, as a part thereof, a temperature-dependent displacing portion which is displaced to a location where the valve part is closed at a temperature equal to or higher than a threshold.

6. The pressure control valve according to claim 5, wherein the temperature-dependent displacing portion is formed of a shape memory alloy.

7. The pressure control valve according to claim 5, wherein the temperature-dependent displacing portion is formed of a bimetal.

8. The pressure control valve according to claim 3, wherein the valve body portion has a projection portion formed at a portion for abutting against the valve seat portion.

9. The pressure control valve according to claim 3, further comprising a sealing material formed on either one of the valve body portion and the valve seat portion at an abutting portion of the valve body portion and the valve seat portion.

10. The pressure control valve according to claim 1, wherein the valve part comprises an elastic body with a through hole provided on a flat plane which is perpendicular to a direction of an action of the transmission mechanism and includes the valve body portion, and wherein the through hole is opened and closed by a tip of the transmission mechanism according to the action of the movable part transmitted by the transmission mechanism.

11. The pressure control valve according to claim 10, wherein the transmission mechanism is formed of a plurality of projection portions provided on the movable part.

12. The pressure control valve according to claim 10, wherein the transmission mechanism is formed of a seat having unevenness on a surface thereof provided between the movable part and the valve part.

13. The pressure control valve according to claim 1, wherein the pressure control valve of the present invention is characterized in that each of the valve part, the movable part, and the transmission mechanism is formed of one of a sheet-shaped member and a plate-shaped member, and those members are stacked to constitute the pressure control valve.

14. The pressure control valve according to claim 1, which is a pressure reducing valve.

15. A method of producing a pressure control valve comprising a movable part which operates by a differential pressure, a valve part comprising a valve seat portion, a valve body portion, and a support portion for supporting the valve body portion, and a transmission mechanism for transmitting an action of the movable part to the valve part, either one of the movable part and the valve part being separated from the transmission mechanism, the method comprising:
forming a movable part using one of a sheet-shaped member and a plate-shaped member;
forming a transmission mechanism using one of a sheet-shaped member and a plate-shaped member;
forming a valve seat portion using one of a sheet-shaped member and a plate-shaped member;
forming a valve body portion and a support portion using one of a sheet-shaped member and a plate-shaped member; and
stacking the above formed components on one another to assemble a pressure control valve.

16. The method according to claim 15, wherein a semiconductor substrate is used in at least a part of one of the sheet-shaped member and the plate-shaped member.

17. The method according to claim 15, wherein at least one of etching, pressing, and injection molding is used for each of the movable part formation, the transmission mechanism formation, the valve seat portion formation, the valve body portion formation, and the support portion formation.

18. The method according to claim 15, comprising:
after the formation of the valve body portion and the support portion or the formation of the valve seat portion, coating at least one of the formed valve body portion and support portion and the formed valve seat portion with a sealing material; and
then assembling the valve body portion and the support portion, and the valve seat portion.

19. A fuel cell system having the pressure control valve set forth in claim 1 mounted thereon.
